(19) United States
(12) Patent Application Publication
(10) Pub. No.: US 2010/0327186 A1
(43) Pub. Date: Dec. 30, 2010

(54) OPTICAL COMPONENTS FOR USE IN HIGH ENERGY ENVIRONMENT WITH IMPROVED OPTICAL CHARACTERISTICS

(75) Inventors: ALFRED A. MARGARYAN, GLENDALE, CA (US); ASHOT A. MARGARYAN, GLENDALE, CA (US)

Correspondence Address: Patent Law Agency, LLC;PETER GANJIAN, 3146 North Verdugo Road, Glendale, CA, 91208-1665, US

(73) Assignee: AFO RESEARCH, INC., GLENDALE, CA (US)

(21) Appl. No.: 12/880,115

(22) Filed: Sep. 12, 2010

Related U.S. Application Data
(63) Continuation-in-part of application No. PCT/US2009/062652, filed on Oct. 29, 2009.
Application No. PCT/US2009/062652 is a continuation-in-part of application No. 12/607,962, filed on Oct. 28, 2009.
Application No. PCT/US2009/062652 is a continuation of application No. 12/607,962, filed on Oct. 28, 2009.
(60) Provisional application No. 61/198,012, filed on Oct. 31, 2008.
(60) Provisional application No. 61/180,880, filed on May 24, 2009.
(60) Provisional application No. 61/185,190, filed on Jun. 8, 2009.
(60) Provisional application No. 61/218,971, filed on Jun. 21, 2009.
(60) Provisional application No. 61/198,012, filed on Oct. 31, 2008.
(60) Provisional application No. 61/180,880, filed on May 24, 2009.
(60) Provisional application No. 61/185,190, filed on Jun. 8, 2009.
(60) Provisional application No. 61/218,971, filed on Jun. 21, 2009.

(51) Int. Cl. G01N 21/00

(52) U.S. Cl. 250/474.1

(57) ABSTRACT

Optical components that maintain transparency (remain clear) in high energy environments, including in applications of high-intensity gamma-ray radiation dosage of 1.29×10⁹ rads and greater, and neutron energy at neutron fluxes ranging from 3×10⁹ to 1×10¹⁴ n/cm² sec and greater, and fluencies ranging from 2×10¹⁶ to 8.3×10²⁰ n/cm² and greater. Further, the optical components have a bulk laser damage threshold of 105+/−20 J/cm², a surface laser damage threshold of 72+/−15 J/cm², a Stokes shift of about 9%, and a fractional thermal loading of about 11%.

### CROSS-REFERENCE TO RELATED APPLICATIONS

This application is a Continuation-In-Part Application claiming the benefit of the co-pending International Patent Application PCT/US2009/062652, with an international filing date of 29 Oct. 2009 that designated the United States U.S.;

This application is also a Continuation-In-Part Application claiming the benefit of the co-pending U.S. Utility Non-Provisional patent application Ser. No. 12/607,962, filed 28 Oct. 2009;

the International Patent Application PCT/US2009/062652 with the international filing date of 29 Oct. 2009 that designated the United States is a Continuation application claiming the benefit of the co-pending U.S. Utility Non-Provisional patent application Ser. No. 12/607,962, filed 28 Oct. 2009;

the International Patent Application PCT/US2009/062652 with the international filing date of 29 Oct. 2009 that designated the United States claims the benefit of the then co-pending U.S. Utility Provisional Patent Application No. 61/198,012, filed 31 Oct. 2008, the then co-pending U.S. Utility Provisional Patent Application No. 61/180,880, filed 24 May 2009, the then co-pending U.S. Utility Provisional Patent Application No. 61/185,190, filed 8 Jun. 2009, and the then co-pending U.S. Utility Provisional Patent Application No. 61/218,971, filed 21 Jun. 2009; AND

the U.S. Utility Non-Provisional patent application Ser. No. 12/607,962, filed 28 Oct. 2009 claims the benefit of the then co-pending U.S. Utility Provisional Patent Application No. 61/198,012, filed 31 Oct. 2008, the then co-pending U.S. Utility Provisional Patent Application No. 61/180,880, filed 24 May 2009, the then co-pending U.S. Utility Provisional Patent Application No. 61/185,190, filed 8 Jun. 2009, and the then co-pending U.S. Utility Provisional Patent Application No. 61/218,971, filed 21 Jun. 2009;

the entire disclosures of all Applications are expressly incorporated by reference in their entirety herein.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

1. Field of the Invention

This invention relates to fluorophosphate based optical components with improved optical characteristics for use in high energy environments.

2. Description of Related Art

Some of the known conventional optical components have some levels of radiation resistance, but that level of resistance is not sufficient for their use in high energy environments.

Examples of optical components with different levels of radiation resistant characteristics can be seen in bismuth metaphosphate based glass systems that solarize after being exposed to a few hundred Kilorads of gamma radiation. Other examples include the SiO₂ base optical components, which are well-known as poor performers under high energy environments in that they darken under very low levels of gamma radiation, making them impractical for uses in high energy environments. Other optical components comprised of phosphate based glasses of varying compositions contain alkaline elements, which are also known to actually reduce and lower the overall radiation resistance of the final product, thus rendering them impractical for use in any high energy environments. Other optical components used include germanium dioxide based network structures, which are not suitable for radiation resistance or detection due to the presence of GeO₂.

With respect to the optical characteristics of the above optical components and, in particular in relation to their surface laser damage threshold, most have a very low surface laser damage threshold as indicated in the following table:

Surface Laser Damage Threshold

| Optical Component | Surface Laser damage threshold |
|---|---|
| Schott glass Products | ~30 J/cm² |
| phosphate glasses LG750 | |
| Corning glass products silica glasses | ~38 +/− 2 J/cm² |
| 7940 | |
| Corning glass products borosilicate glass | ~32 J/cm² |
| 0211 | |
| Bismuth containing fluorophosphate | ~29 J/cm² |
| glass | |

Therefore, the above optical components cannot be used in high laser energy environments, which requires thresholds that are 60 J/cm² or higher.

Accordingly, in light of the current state of the art and the drawbacks to current optical components, a need exists for an optical component that would have a high-energy resistance and superior active and passive optical characteristics.

### BRIEF SUMMARY OF THE INVENTION

The present invention provides optical components that maintain transparency (remain clear) in high energy environments, including high-intensity gamma-ray radiation dosage of 1.29×10⁹ rads and greater, and high neutron energy at neutron fluxes ranging from 3×10⁹ to 1×10¹⁴ n/cm² sec and greater, and fluencies ranging from 2×10¹⁶ to 8.3×10²⁰ n/cm² and greater. Further, the optical components have a bulk laser damage threshold of 105+/−20 J/cm², a surface laser damage threshold of 72+/−15 J/cm², a Stokes shift of about 9%, and a fractional thermal loading of approximately 11%.

One exemplary optional aspect of the present invention provides an optical component, comprising:

a metaphosphate Ba(PO₃)₂, 10 to 60 mol %;

a metaphosphate Al(PO₃)₃, 10 to 60 mol %;

fluorides BaF₂+RF₃, 20 to 90 mol %;

where R is selected from one of Y and La;

with dopant selected from one of Yb₂O₃ and YbF₃ 0.5 to 10 wt % over 100.

Another exemplary optional aspect of the present invention provides an optical component, comprising:

a metaphosphate Ba(PO₃)₂, 20 to 50 mol %;

a metaphosphate Al(PO₃)₃, 10 to 60 mol %;

fluorides BaF₂+RF₃, 20 to 90 mol %;

where R is selected from one of Y and La;

with dopant selected from one of Yb₂O₃ and YbF₃ 0.5 to 15 wt % over 100.

A further exemplary optional aspect of the present invention provides an optical component, comprising:

a metaphosphate Ba(PO₃)₂, 10 to 60 mol %;

a metaphosphate AI(PO₃)₃, 10 to 60 mol %;

fluorides BaF₂+RF₃, 10 to 75 mol %;

where R is selected from one of Y and La;

with dopant selected from one of Yb₂O₃ and YbF₃ 0.5 to 10 wt % over 100.

Another exemplary optional aspect of the present invention provides an optical component, comprising:

a metaphosphate Ba(PO₃)₂, 5 to 60 mol %;

a metaphosphate AI(PO₃)₃, 5 to 60 mol %;

fluorides BaF₂+RF₃, 10 to 90 mol %;

where R is selected from one of Y and La;

with dopant selected from one of Yb₂O₃ and YbF₃ 0.2 to 20 wt % over 100.

Still another exemplary optional aspect of the present invention provides an optical component, comprising:

a metaphosphate Ba(PO₃)₂ in mol %,

a metaphosphate Al(PO₃)₃ in mol %,

fluorides BaF₂+RFx in mol %,

with dopant selected from one of Yb₂O₃ and YbF₃ over 100 percent (wt %) of the composition above Yb;

where:

R is selected from the group consisting of Mg, Ca, Bi, Y, La;

x is an index representing an amount of fluorine (F) in the compound RFx;

with the optical components maintaining transparency in high energy environments:

including application of high-intensity gamma-ray radiation dosage of 1.29×10⁹ rads and more; and

application of neutron energy at neutron fluxes ranging from 3×10⁹ to 1×10¹⁴ n/cm² sec and more, and fluencies ranging from 2×10¹⁶ to 8.3×10²⁰ n/cm² and greater; and

with a bulk laser damage threshold of 105+/−20 J/cm², and a surface laser damage threshold of 72+/−15 J/cm².

One exemplary optional aspect of the present invention provides an optical component, wherein:

the optical component is one of a solid state laser host and solid state amplifier host, with dopant selected from one of Yb₂O₃ and YbF₃ 0.5 to 5 wt % over 100.

Another exemplary optional aspect of the present invention provides an optical component, wherein:

the optical component is a thin disc laser host, with dopant selected from one of Yb₂O₃ and YbF₃ 1 to 20 wt % over 100.

A further exemplary optional aspect of the present invention provides an optical component, wherein:

the optical component is one of a fiber laser host and fiber amplifier host with dopant selected from one of Yb₂O₃ and YbF₃ 0.5 to 3 wt % over 100.

Still a further exemplary optional aspect of the present invention provides an optical component, wherein:

the optical component is one of a window, mirror, and thin film covering for a solar panel, with dopant selected from one of Yb₂O₃ and YbF₃ 1 to 10 wt % over 100.

Another exemplary optional aspect of the present invention provides an optical component, wherein:

the optical components is one of a lens, with dopant selected from one of Yb₂O₃ and YbF₃ 0.5 to 5.5 wt % over 100.

A further exemplary optional aspect of the present invention provides an optical component, wherein:

a Stokes shift of the optical component is about 9%, and a fractional thermal loading of about 11%.

Still a further exemplary optional aspect of the present invention provides an optical component, wherein:

the Yb dopant simultaneously functions to act as a desolarizer in high energy environments to maintain the optical components transparent and functions to act as laser dopant, when stimulated.

Another exemplary aspect of the present invention provides an optical component, comprising:

fluorophosphate glass system that maintains transparency in high energy environments, including in high-intensity gamma-ray radiation dosage of 1.29×10⁹ rads and greater, and neutron energy at neutron fluxes ranging from 3×10⁹ to 1×10¹⁴ n/cm² sec and greater, and fluencies ranging from 2×10¹⁶ to 8.3×10²⁰ n/cm² and greater; and

having a bulk laser damage threshold of 105+/−20 J/cm², and a surface laser damage threshold of 72+/−15 J/cm².

Another exemplary optional aspect of the present invention provides an optical component, wherein:

the optical component is one of:

a solid state laser host; a solid state amplifier host; a thin disc laser host; a fiber laser host; a fiber amplifier host; a window, a thin film covering for a solar panel, a mirror and a lens.

Still another exemplary optional aspect of the present invention provides an optical component, wherein:

a Stokes shift of the optical component is about 9%, and a fractional thermal loading of about 11% when stimulated with 945 nm wave energy.

A further exemplary optional aspect of the present invention provides an optical component, wherein:

the optical components are polished to a Roughnessₚ₋ᵥ of 118 A° to 132 A°.

Still a further exemplary optional aspect of the present invention provides an optical component, wherein:

a draw temperature T_{D} of the optical components to form an optical fiber is substantially different from that of a crystallization temperature T_{C}, with the draw temperature equaling to about 690° C.

Another exemplary optional aspect of the present invention provides an optical component, wherein:

fluorophosphate glass system includes a Yb dopant that simultaneously functions to act as a desolarizer in high energy environments to maintain the optical components transparent and functions to act as laser dopant, when stimulated.

Still another exemplary optional aspect of the present invention provides an optical component, wherein:

the optical component is a lens with an Abbe number of approximately 64 to 68 remains constant regardless of an increase in linear refractive index, with non-linear refractive index remaining low at about n₂=1.42×10⁻¹³ esu.

Another exemplary optional aspect of the present invention provides an optical component, wherein:

fluorophosphate glass system is comprised of:

a metaphosphate Ba(PO₃)₂ in mol %,

a metaphosphate Al(PO₃)₃ in mol %,

fluorides BaF₂+RFx in mol %,

with dopant selected from one of Yb₂O₃ and YbF₃ over 100 percent (wt %) of the composition above Yb;

where:

R is selected from the group consisting of Mg, Ca, Bi, Y, La; and

x is an index representing an amount of fluorine (F) in the compound RFx.

Another exemplary aspect of the present invention provides a radiation detection system, comprising:

an optical component having fluctuating optical characteristics associated with variations in environmental radiation levels; and

a detection mechanism that detects fluctuations in optical characteristics of the optical component, thereby enabling determination of environmental radiation levels.

Another exemplary optional aspect of the present invention provides a radiation detection system, wherein the detection mechanism monitors variations in optical characteristics of the optical component, with the optical characteristics including at least one of optical density, optical absorption, optical transparency, and change in valence energy of the optical component.

Another exemplary optional aspect of the present invention provides a radiation detection system, wherein environmental radiation levels are determined based on the variations of the optical characteristics of the optical components from known optical characteristics.

Another exemplary optional aspect of the present invention provides a radiation detection system, wherein environmental radiation levels are determined based on deviations of the variations of the optical characteristics of the optical components from known optical characteristics.

Another exemplary optional aspect of the present invention provides a radiation detection system, wherein the optical component is comprised of a dopant selected from one of Yb₂O₃ and YbF₃ over 100 percent (wt %) of the composition above Yb, with single optical absorption peak within wavelengths ranging from about 970 nm to about 980 nm.

Another exemplary optional aspect of the present invention provides a radiation detection system, comprising:

an optical component having fluctuating optical absorption level associated with variations in environmental radiation levels; and

a detection mechanism that detects fluctuations in optical absorption level of the optical component;

the detection mechanism includes:

a signal detector that detects signals associated with the optical absorption levels of the optical component;

a signal amplifier for amplification of the detected signals;

a microprocessor for determining variations in the detected signals to thereby determine variations in environmental radiation levels.

Another exemplary optional aspect of the present invention provides a radiation detection system, wherein a microprocessor is associated with a memory that retains detected signals information, and includes a comparator for determining variations in detected signals, which are reflective of variations in optical absorption levels of the optical component.

Another exemplary optional aspect of the present invention provides a radiation detection system, wherein the detection mechanism further includes:

an optical driver unit for generating Infrared (IR) signal having a wavelength ranging from λₐ=970 nm to λ_{b}=980 nm that is absorbed by the optical component for generating a substantially constant absorption signal with a first peak optical absorption level P₀;

the optical component generating a second absorption signal within the wavelength range λₐ=970 nm to λ_{b}=980 nm with a second peak optical absorption level associated with externally applied environmental radiation;

a comparator for determining differences between the second peak optical absorption level and the first peak optical absorption level for determining environmental radiation levels.

Another exemplary optional aspect of the present invention provides a radiation detection system, wherein the Infrared (IR) signal has a wavelength λ₀=976 nm.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is an exemplary view of a first optical component sample of the present invention in an exemplary form of an exemplary fiber core in accordance with the present invention;

FIG. 1B is an exemplary view of the first optical component shown in FIG. 1A, but after application of high energy in accordance with the present invention;

FIG. 1C is an exemplary view of a second optical component sample of the present invention in an exemplary form of a rectangular-cube, after the application of high energy in accordance with the present invention;

FIG. 2 is an exemplary optical component of the present invention, which was subjected to a laser damage threshold test in accordance with the present invention;

FIG. 3A is view of an exemplary optical component of the present invention in the exemplary form of a solid state laser/amplifier host in accordance with the present invention;

FIG. 3B is a view of an exemplary optical component of the present invention in the exemplary form of a disc in accordance with the present invention;

FIG. 3C is a view of an exemplary optical component of the present invention in the exemplary form of a disc that may be cut, shaped, and polished into a lens in accordance with the present invention;

FIG. 4A exemplarily shows a topography of one polished side of a cubed optical component of the present invention;

FIG. 4B is a table, which details the numerical data with respect to the surface quality in terms of polished optical component end product for the side shown in FIG. 4A;

FIG. 4C exemplarily shows a topography of another polished side of the same cubed optical component of the present invention shown in FIG. 4A; and

FIG. 4D is a table, which details the numerical data with respect to the surface quality in terms of polished optical component end product for the side shown in FIG. 4C; and

FIG. 5 is a view of an exemplary optical component in the exemplary form of glass-rod in accordance with the present invention;

FIG. 6A is an exemplary, general schematic illustration of a radiation detection system in accordance with the present invention;

FIG. 6B is an exemplary, general schematic illustration of another radiation detection system in accordance with the present invention; and

FIG. 6C is an exemplary graphical illustration of one, non-limiting example of an optical characteristic of the optical component that is used in the radiation detection systems illustrated in FIGS. 6A and 6B in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For the sake of convenience and clarity, this disclosure uses the phrase “energy” in terms of both wave and particle energies capable of producing at least 6.4 eV of energy. Further, this disclosure defines high energy wave (i.e., high Electromagnetic Radiation (EMR) or Electromagnetic Radiation Pulse (EMP)) as those in the gamma ray frequencies (approximately greater than 10¹⁹ Hz or higher). In addition, this disclosure defines high particle energy in terms of average neutron fluxes of at least 3×10⁹ n/cm²sec, and average neutron fluencies of at least 2×10¹⁶ n/cm². Accordingly, this invention defines the collective phrases “high energy,” “high radiation,” “high radiation energy,” “high energy environment,” “heavily irradiated environment” and so on as energy defined by the above high wave energy and high particle energy parameters. Further more, this disclosure defines the term “radiation” as energy that is radiated or transmitted in the form of rays or waves or particles.

In addition, throughout the disclosure, the words “solarize” and its derivatives such as “solarization,” “solarized,” and so on define the darkening, browning, and/or burning up of materials due to exposure to various amounts of applied energy (e.g., high energy). The words “desolarize” and its derivatives such as “desolarization,” “desolarized,” and so on define the ability of a material to continuously resist (or reverse) the solarization process while exposed to high energy. The phrase “desolarizer” may be defined as agent(s) that reverse(s) the act of solarization (e.g., reverse the act of burning up or browning of the optical component when in heavily irradiated environment).

The optical components of the present invention may be used as a host of a system, with “host” defined as a medium (passive or active) within the system that serves to perform one or more function. One non-limiting example of an optical component of the present invention used as a host may include a laser glass (active), which is the medium that serves as laser material (or laser host material) that functions to emit laser energy when excited.

The optical components of the present invention have applications in numerous fields, and may be used in high energy environments that may also require high laser damage threshold or shielding against radiation. The optical components of the present invention may be used as radiation resistant shielding components that shield or protect against radiation. Non-limited, non-exhaustive list of examples of applications of the optical components of the present invention may include optical windows, substrate for optical mirrors, substrate and window for free electron laser, solar panel covers, space solar panel covers, lenses, fiber, and etc. Other non-limited, non-exhaustive list of examples of applications of the optical components of the present invention used as hosts may include fiber amplifier host, solid state amplifier host, fiber lasers host, solid state laser hosts (e.g., thin disc laser (active mirror or mirror substrates)), etc.

In particular, this invention provides an optical component based on fluorophosphate glass systems with Ytterbium dopant, but without using Alkali or Alkali-fluorides, lead or lead-fluoride, or bismuth metaphosphate. The optical components of the present invention are 100% lead free, which makes them environmentally friendly. In addition, the lead free optical components of the present invention further provide a very high leaching resistance, confining any potential radiation residue within the optical component. That is, after exposure to radiation energy, the optical component of the present invention maintain and confines most radiation residue within (prevents leaching), even if placed into other solutions such as water or exposed to other moisture content (e.g., acidic or base). Non-limiting examples of fluorophosphate based glass systems (but without lead or lead-fluoride), which may be used in the optical components of the present invention are disclosed in the U.S. Patent Application Publication 2003/0040421 to Margaryan, the entire disclosure of which is expressly incorporated by reference in its entirety herein.

In particular, the optical components of the present invention may include the following fluorophosphate glass systems {Ba(PO₃)₂, Al(PO₃)₃, BaF₂+RFx}+{dopant}, where RFx is selected from the group MgF₂, CaF₂, BiF₃, or related fluorides (but not Alkali-fluorides or lead-fluoride), and the dopant may include, at minimum, Yb₂O₃ or YbF₃. Optionally, co-dopants such as MnO or MnF₂ may also be included. The glass system Ba(PO₃)₂—Al(PO₃)₃—BaF₂+RFx+dopant use dopant from the group of oxides or fluorides of the rare earth elements over 100 percent (wt %) of the composition above Yb and mixtures thereof.

An exemplary, preferred material for the present invention are optical components that are based on or contain Ba(PO₃)₂, 10 to 60 mol %; Al(PO₃)₃, 10 to 60 mol %; BaF₂+RFx, 20 to 90 mol % (where RFx is selected from the group MgF₂, CaF₂, BiF₃); and one of a dopant of Yb₂O₃ of 0.5 to 20 weight % or fluoride YbF₃ of 0.5 to 20 weight %. The raw compounds used for glass formation are: Barium Metaphosphate, Ba(PO₃)₂, and Aluminum Metaphosphate, Al(PO₃)₃, which are considered chemically stable (durable) substances, resistant against dissolving in water or other moisture content (e.g., acidic or base).

Another non-limiting example of fluorophosphate based glass system that may be used in the optical components of the present invention may include fluorophosphate glass systems with Ytterbium dopant containing Ba(PO₃)₂, Al(PO₃)₃, BaF₂ and RFx, where RFx is selected from the group MgF₂, CaF₂, BiF₃, YF₃, LaF₃, or related fluorides (but not Alkali-fluorides or lead-fluoride) and, one of Yb₂O₃ and YbF₃. That is, glass system Al(PO₃)₃—Ba(PO₃)₂—BaF₂+RFx+dopant use dopant from the group of oxides or fluorides of the rare earth elements over 100 percent (wt %) of the composition above Yb and mixtures thereof. The introduction of Yttrium Fluoride YF₃ and Lanthanum Fluoride LaF₃ improved the overall performance and efficiency of these glasses. The preferred material for the optical components using the YF₃ may contain Ba(PO₃)₂, 10 to 60 mol %; Al(PO₃)₃, 10 to 60 mol %; BaF₂+RFx, 20 to 90 mol %; and one of a dopant of Yb₂O₃ of 0.5 to 20 weight % or fluoride YbF₃ of 0.5 to 20 weight %.

The YF₃ dramatically increased the glass forming domain allowing the introduction of up to 60 mol % of YF₃, and improved the optical properties such as higher Emission Cross Section from 0.87 to 1.37 pm² at lasing wavelength of approximately 996 nm, extremely high Gain Coefficient G=0.95 to 1.65 ms*pm⁴ and Quantum Efficiency of about 90-94%. These improvements further enhanced the performance of the overall radiation resistant by improving the optical characteristics of the radiation resistant optical components such as radiation resistant laser host material and fibers. The LaF₃ Lanthanum Fluoride dramatically improves the Abbe Number (dispersion) to 64-68 and reduces the chromatic aberration by about 20-30%. Stable Abbe Number and low chromatic aberration is extremely important for the radiation resistant lenses. The above improved characteristics due to the introduction of LaF₃ further enhances the accuracy and the precision of the radiation resistance lenses and allows the creation of smaller and flatter lenses. The reduction of the sizes of the lenses increases their overall application in different industries, including optical based electronics systems. The presence of BaF₂+RFx (YF₃, LaF₃, CaF₂, MgF₂, and BiF₃) effectively increases the chemical durability of the laser material. In the grouping of glasses according to chemical stability of non-silicate glasses relating to humidity or moisture, the optical components of the present invention are considered to be stable.

It should be noted that although references to optical components and in particular, glass systems used in the optical components throughout most (but not all) of the remainder of the disclosure may be directed to non-limiting examples of fluorophosphate based glass systems disclosed in the U.S. Patent Application Publication 2003/0040421 to Margaryan, these references are only meant as illustrative and for convenience of example and should not be limiting.

Radiation resistant characteristics of the optical components of the present invention provide high resistance against high levels of energy without change in the transparency (e.g., browning or darkening of the optical component—no solarization). The combination of unique molecular structure, such as large atomic radius, high electro-negativity of fluorine, and the reverse change of valency of Yb (III) dopant enables these optical components to achieve high solarization resistance. During the gamma ray or neutron fluxes (and fluencies) exposure, the Yb (III) dopant creates a continuing de-solarization process that enable the optical component of the present invention to remain transparent due to the Yb (III) having a remarkably high transformation of valency of approximately 90-95%. That is, when the Yb (III) is bombarded by the gamma, neutron or other high energy (radiation and or particle), the transformation of the valency of Yb from Yb(III) to Yb(II) and vice versa constantly reoccurs, which allows the glass matrix to remain transparent, in accordance with the following:

Yb(III)+G+e<->Yb(II)-G-e

Yb(III)+e<->Yb(II)-e

Yb(III)<->Yb(II)

where G is energy of the Gamma ray, and e is the electron.

In order for Yb (III) to become ionized and to create the transformation process of Yb (III) to Yb (II) and vice versa, a 6.4 eV (electron volt) energy is required. Yb(III) is Yb that is combined with Oxygen or Fluoride in the form of Yb₂O₃ or YbF₃ in its normal state, and Yb(II) is the result of Yb(III) gaining an electron as a result of excitation of the dopant due to application of radiation. Wavelengths starting from 190 nm (e.g., far Ultraviolet—UV) up to high levels of X-Ray and Gamma ray are capable of producing the required 6.4 eV or higher for the Yb (III) dopant to achieve the continuous reciprocating transformation, thereby, maintain the optical components of the present invention transparent in high energy environments. The Electron Volt Energy for each Wavelengths can be measured by utilizing the following formula:

$$E = hf = \frac{hc}{λ} = \frac{1240 nm}{λ} eV$$

Where E is energy, f is frequency, λ is the wavelength of a photon, h is Planck's Constant and is c is the speed of light.

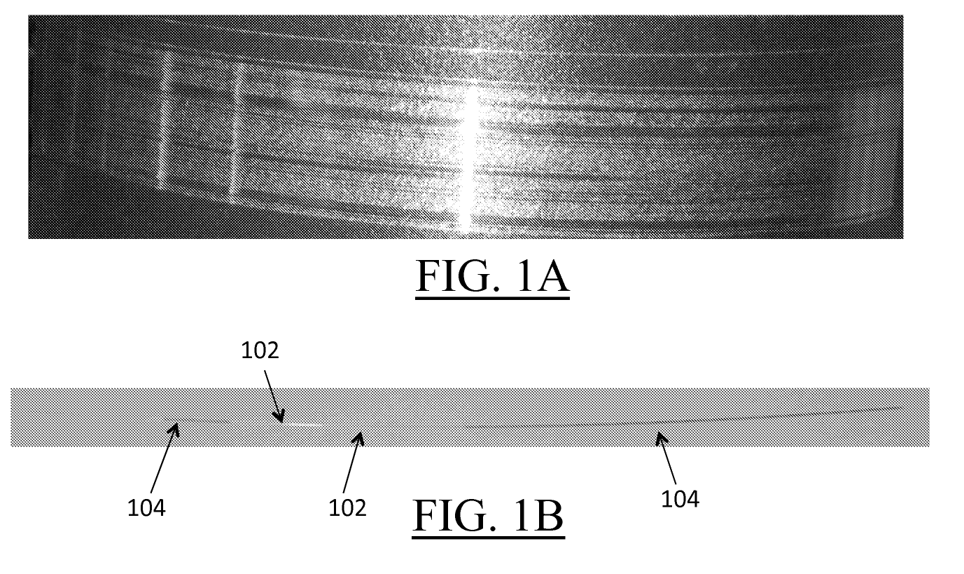

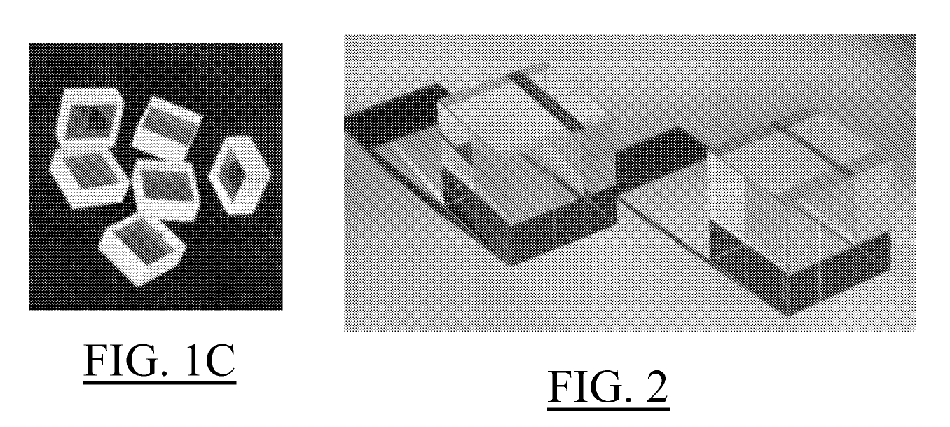

Two different optical component samples of the present invention have been tested in high-energy environments (i.e., high levels of gamma radiation and neutron energy), with the result that the samples maintained their transparency. FIG. 1A is an exemplary view of the first optical component sample of the present invention in the exemplary form of a fiber core only (without the cladding) with exemplary dimensions of about 179 μm of diameter, before the application of any high energy radiation. Further included with the fiber core of the present invention illustrated in FIG. 1A is an optional organic acrylate-coating (of about 284 μm diameter), which enables users to actually handle the fiber core shown in FIG. 1A. FIG. 1B is an exemplary view of the same first optical component sample shown in FIG. 1A, but after application of high energy. FIG. 1C is an exemplary view of a second optical component sample of the present invention in the exemplary form of a rectangular-cube with exemplary dimensions of 3 mm×5 mm×5 mm, after the application of high energy.

It should be noted that both of the optical component samples of the present invention (FIG. 1A and FIG. 1C) were transparent in the visible spectral region before exposure to any radiation. The tests that were conducted for both samples of the present invention were in a high-intensity gamma-ray environment, and were done so at a level of 1.8×10⁶ rad per hour for 30 days in Cobalt-60 irradiator, where the total gamma-radiation dosage was 1.29×10⁹ rad. After withstanding such high levels of radiation, both of the optical component samples of the present invention remained transparent with no occurrence of any solarization. As shown in FIG. 1B, the actual optical sample fiber remained clear and transparent (sections 102). The darkened sections 104 of the fiber sample of the present invention shown in FIG. 1B is the optional organic acrylate-coating that burned as a result of the exposure to high energy environment, which is easily wiped clean with a cloth. Further, as illustrated in FIG. 1C, the second optical component sample of the present invention also remained transparent.

In addition, a second set of identical optical components (same as above optical component samples, including same size and dimensions as above) of the present invention underwent high radiation neutron testing. Both optical components were transparent in the visible spectral region before exposure to any radiation. The tests for neutron radiation were conducted at neutron fluxes ranging from 3×10⁹ to 1×10¹⁴ n/cm² sec and fluencies ranging from 2×10¹⁶ to 8.3×10²²⁰ n/cm² for both samples. When exposed to the above radiation for over 90 days, both of the optical component samples of the present invention maintained their transparency, with identical results as those illustrated in FIGS. 1B and 1C. Accordingly, the radiation resistant characteristics of the optical components of the present invention provide high resistance against high levels of radiation (wave or particle) without change in the transparency (e.g., no browning or darkening of the optical component—no solarization).

In addition to providing high radiation resistance (wave or particle), the optical components of the present invention also have a high level of resistance against laser damage. FIG. 2 exemplarily shows an optical component of the present invention, which was subjected to a laser damage threshold test (detailed below). As detailed in table II below, the optical components of the present invention have a high laser damage threshold, which is in part due to the addition of Ytterbium as a dopant. Accordingly, the optical components of the present invention (for example, a solid state laser or amplifier host) may be used in high energy environments as high energy optical components with high levels of laser damage threshold. In addition, due to unique spectroscopic properties, the optical components of the present invention can be used for ultraviolet, visual and near infrared optics in the band of about 250 to approximately 5,000 nm. The optical components of the present invention have high chemical durability, and are free of alkali-fluorides and bismuth metaphosphate.

Current commercially available high power vitreous optical components are mainly based on Nd or Er dopants. The optical components of the present invention use Yb dopants, which produce more than 1 Kw of energy and have low heat dissipation when stimulated to generate a laser effect. For example, fractional thermal loading of about 11% is produced when the optical laser product of the present invention having Yb dopant is stimulated or pumped with 945 nm wave energy. Conventional optical components that are doped with Nd generate a large amount of thermal loading of about 32% when stimulated or pumped with only 808 nm wave energy. It should be noted that generated thermal load in high power lasers is a great concern in that the higher the generated thermal loading, the lower the laser energy output. As the thermal load increases, it reduces the laser output efficiency. In the above example, the output efficiency of the high power optical component of the present invention with Yb dopant is at approximately 89%. Conventional optical components with Nd dopant have a mere 68% output efficiency with the remaining energy converted and dissipated as heat. In addition, Quantum Defects or Stokes shift are only 9% in Yb doped laser optical components of the present invention, where as they are about 24% in Nd doped laser optical components. That is, the actual wavelength output from the laser host of the present invention with Yb dopant is varied by only 9% from its supposed ideal wavelength output. This is significant in that, at high powers, the laser host of the present invention (with the Yb dopants) generate laser wavelengths that are close to being pure (or at worst, shift by a mere 9%) from their supposed ideal laser wavelength output.

During the excitation process (for laser applications) under high levels of energy, the Yb dopant in the optical components of the present invention can concurrently perform two functions. One function of the Yb is to act as a desolarizer by maintaining the optical component of the present invention transparent due to the constant desolarization process of Yb when used in high energy environments (mentioned above). The other function of the Yb within the optical component of the present invention is to act as laser dopant, when stimulated. That is, when used as a laser optical component, some of the Yb dopants within the optical component of the present invention are excited to generate output laser energy, when stimulated. It should be noted that both functions can occur simultaneously. That is, the optical component of the present invention when used as a laser product and placed in a high energy environment, when excited, the Yb dopant will function as a laser dopant and also, function as desolarizer. Accordingly, the optical components of the present invention are ideal for use in laser applications, high energy applications, or simultaneously, in both laser and high energy applications. For example, the use of optical components of the present invention as laser hosts are ideal for use in high energy laser devices that may be used for the generation of nuclear energy through the process of nuclear fusion or in applications that need to work in deep space (where exposure to different types of radiation is imminent).

Examples of effective compositions and properties of the optical components of the present invention are illustrated in Table I based on mol percent and weight percent.

TABLE I

| | | | Yb₂O₃ or YbF₃ | | | Emission | Gain | |
|---|---|---|---|---|---|---|---|---|
| Composition of Glass | | | Dopant | Refractive | | Cross-section | Coefficient | Quantum |
| (mol %) | | | (wt %) | Index | Density | pm² | (ms*pm⁴) | Efficiency |
| Ba(PO₃)₂ | Al(PO₃)₃ | BaF₂ + RFx | Over 100% | nD | g/cm³ | @ 996 nm | G | % |
| 40 | 48 | 12 | 1 | 1.5878 | 4.15 | 0.87 | 0.95 | 90 |
| 35 | 13 | 52 | 1 | 1.5886 | 4.20 | 0.95 | 1.55 | 92 |
| 28 | 10 | 62 | 1 | 1.5895 | 4.28 | 1.29 | 1.60 | 93 |
| 10 | 16 | 74 | 1 | 1.5914 | 4.32 | 1.37 | 1.65 | 94 |

Where RFx is one of MgF₂, CaF₂, BiF₃, YF₃, LaF₃.

In the above example, Yb₂O₃ or YbF₃ would be used as dopant.

The following procedures were used in testing for laser damage threshold (both bulk and surface) of the optical components of the present invention shown in FIG. 2:

1—Started at a low fluence/irradiance and tested 10 sites at 1 shot/site. Based on the number of sites damaged, the percentage of damage at that fluence was calculated.

2—Next, the fluence/irradiance was increased and another 10 sites at single shot/site were performed.

3—This procedure was repeated until a fluence/irradiance damaged 10/10 sites.

4—Next, the plotted percentage damage was tested versus the Fluence/Irradiance. The data was fitted to a line and the intercepted with the x-axis of the threshold value. All values are detailed in the following table II.

The bulk laser damage threshold for the optical components of the present invention was found to be 105+/−20 J/cm2. The laser damage threshold tests showed that surface laser damage threshold for the optical components of the present invention was found to be 72+/−15 J/cm2. The laser source was: Nd:YAG, Beam Radius=9.5 micron (Hwe−1 M), Pulsewidth=1.7 ns (Hwe−1 M), Wavelength=1.064 micron. This newly discovered laser damage threshold data relating to the optical components of the present invention seems to be the highest among most known commercially available optical components currently in existence.

TABLE II

| | Avg Fluence (J/cm²) | Avg Irradiance (GW/cm²) | % DMG |
|---|---|---|---|
| Bulk | 100 | 33.1876 | 0 |
| | 125 | 41.4845 | 10 |
| | 145.1153 | 48.16031485 | 20 |
| | 182.8112 | 60.67069616 | 50 |
| | 225.0739 | 74.69668157 | 60 |
| | 248.028 | 82.31458645 | 70 |
| | 270.4212 | 89.7463645 | 40 |
| | 295.6787 | 98.12871882 | 70 |
| | 319.9747 | 106.1919986 | 30 |
| | 371.7115 | 123.3621978 | 80 |
| | 424.5899 | 140.911298 | 80 |
| | 481.3942 | 159.763286 | 100 |
| Surface | 9.714412 | 3.22398243 | 0 |
| | 21.25153 | 7.052877027 | 0 |
| | 47.91108 | 15.9005484 | 0 |
| | 72.02686 | 23.90400168 | 0 |
| | 99.76801 | 33.11063192 | 30 |
| | 115.3912 | 38.29559336 | 30 |
| | 131.6353 | 43.68662377 | 60 |
| | 148.6606 | 49.33690225 | 50 |
| | 166.8075 | 55.35943438 | 40 |
| | 186.5968 | 61.9270522 | 50 |

Beam Radius = 9.5 μm (HW1/eM)
Pulsewidth = 1.7 ns (HW1/eM)
Wavelength = 1.064 μm
Testing method: 10 sites at each fluence, 1 shot per site
% DMG = percentage (N/10 * 100) of sites damaged at given fluence

As stated above, the optical components of the present invention have applications in numerous fields that may be used in high energy environments that may also require high laser damage threshold. Non-limited, non-exhaustive examples of applications may include windows, substrates for optical mirrors, space solar panel covers, lenses, fiber, fiber amplifier hosts, fiber laser hosts, solid state amplifier hosts, solid state laser hosts (e.g., thin disc laser (active mirror)), etc. The amount or concentration of Yb₂O₃ or YbF₃ dopants within the optical components of the present invention to provide radiation resistant products with superior optical characteristics may vary depending on the specific application of the optical component, including the optical component physical dimensions. For example, for active optical components of the present invention (e.g., laser hosts, etc.) there is a need to balance dopant-concentration quenching in relation to optimized optical emission and optical component radiation resistance characteristics of the optical component when Yb₂O₃ or YbF₃ dopants are added. For non-active optical components of the present invention (e.g., an optical window), there is a need to balance dopant-concentration quenching in relation to optimized transparency and optical component radiation resistance characteristics when Yb₂O₃ or YbF₃ dopants are added. Accordingly, the Table III below is an exemplary, non-exhaustive, non-limiting, listing of the amounts or concentration of Yb₂O₃ or YbF₃ dopants needed for a set of exemplary products.

TABLE III

| | Yb₂O₃ (YbF₃)(wt. %) Dopet Radiation Resistant with High Laser | | | | |
|---|---|---|---|---|---|
| | Damage Threshold Optical Components | | | | |
| Composition of the | Solid State Laser/ | Thin Disc | Fiber Laser/ | Windows, Mirrors, | |
| Optical Component | Amplifier host | Laser host | Amplifier host | Solar Panel Covers | Lens |
| Ba(PO₃)₂, 10 to 60 mol %; | 0.5-5 | 1-10 | 0.5-3 | 1-6 | 1-5 |
| Al(PO₃)₃, 10 to 60 mol %; | | | | | |
| BaF₂ + RFx, 20 to 90 mol %; | | | | | |
| Ba(PO₃)₂, 20 to 50 mol %; | 1-3 | 2-15 | 0.5-2.5 | 2-8 | 0.5-4.5 |
| Al(PO₃)₃, 10 to 60 mol %; | | | | | |
| BaF₂ + RFx, 20 to 90 mol %; | | | | | |
| Ba(PO₃)₂, 10 to 60 mol %; | 0.5-2.5 | 3.5-6 | 1-1.5 | 1.5-10 | 1.5-5.5 |
| Al(PO₃)₃, 10 to 60 mol %; | | | | | |
| BaF₂ + RFx, 10 to 75 mol %; | | | | | |
| Ba(PO₃)₂, 5 to 60 mol %; | 0.2-3 | 4-20 | 0.5-2 | 3-10 | 2-5 |
| Al(PO₃)₃, 5 to 60 mol %; | | | | | |
| BaF₂ + RFx, 10 to 90 mol %; | | | | | |

Where RFx is one of MgF₂, CaF₂, BiF₃, YF₃, LaF₃.

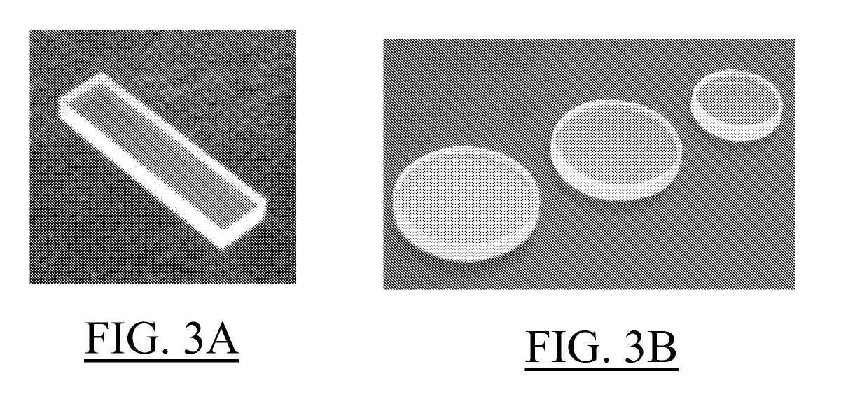

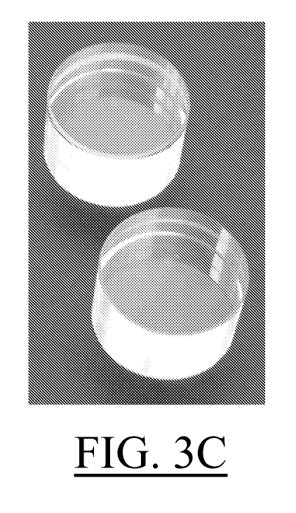

FIG. 3A is a view of an exemplary solid state laser/amplifier host in accordance with the present invention, which may comprise of composition and dopant amounts or concentrations detailed in Table III. For example, as detailed in Table III, for a solid state laser/amplifier host shown in FIG. 3A, the optical component composition may include Ba(PO₃)₂, 10 to 60 mol %; Al(PO₃)₃, 10 to 60 mol %; BaF₂+RFx, 20 to 90 mol %; with Yb₂O₃ or YbF₃ dopant concentration between 0.5 to 5 wt %. As detailed in Table III, RFx is one of MgF₂, CaF₂, BiF₃, YF₃, LaF3. Accordingly, the solid state laser/amplifier host of the present invention shown in FIG. 3A with the mentioned composition concentrations detailed in Table III provides low dopant-concentration quenching, high optical emission, and high radiation resistance.

FIGS. 1C and 2 are views of exemplary windows in accordance with the present invention, which may be shaped and polished into mirrors, thin film solar panel covers, etc. The optical components of FIGS. 1C and 2 may comprise of composition and dopant amounts or concentrations detailed in Table III. For example, as detailed in Table III, for a window shown in FIGS. 1C and 2, the optical component composition may include Ba(PO₃)₂, 10 to 60 mol %; Al(PO₃)₃, 10 to 60 mol %; BaF₂+RFx, 20 to 90 mol %, with Yb₂O₃ or YbF₃ dopant concentration of about 5 wt %. As detailed in Table III, RFx is one of MgF₂, CaF₂, BiF₃, YF₃, LaF3. Accordingly, the window of the present invention shown in FIGS. 1C and 2 with the mentioned composition concentrations detailed in Table III provides low dopant-concentration quenching, high optical transparency, and high radiation resistance.

As mentioned above, the windows shown in FIGS. 1C and 2 can be made into a mirror by a coating on one side and used as a mirror substrate. In addition, the glass windows of FIGS. 1C and 2 can be cut and polished and be used as a solar panel cover, with a thickness of approximately 200 to 250 microns. That is, the optical components of the present invention (shown in FIGS. 1C and 2) may also be prepared in large plates, the sizes of which are based on the manufacturing facility. In general, the glass plate may be softened in temperatures ranging from about 550° C. to 650° C. and rolled through rolling machinery. Once the glass is reduced to about a 3 mm thickness, the plates are transferred into a final shaping and polishing facility to achieve the desired final shape and thickness. In the experiment to demonstrate the practical manufacturing of the optical solar panel cover of the present invention, the optical components shown were successfully polished up to 250 microns in thickness, which considerably improved transparency by about 90% from 250 nm to 5000 nm. The thinner the glass is, the higher its transparency.

FIG. 3B is a view of an exemplary optical component of the present invention in the form of a thin disc in accordance with the present invention, which may comprise of composition and dopant amounts or concentrations detailed in Table III. For example, as detailed in Table III, for a thin disc laser hosts shown in FIG. 3A, the optical component compositions may include Ba(PO₃)₂, 10 to 60 mol %; Al(PO₃)₃, 10 to 60 mol %; BaF₂+RFx, 20 to 90 mol %; with Yb₂O₃ or YbF₃ dopant concentration of approximately 1-10 wt %. As detailed in Table III, RFx is one of MgF₂, CaF₂, BiF₃, YF₃, LaF3. Accordingly, the thin disc laser hosts of the present invention shown in FIG. 3B with the mentioned composition concentrations detailed in Table III provides low dopant-concentration quenching, high optical emission, and high radiation resistance. It should be noted that the thin disk laser host material can be sliced, shaped, and polished to approximate thickness of 150 to 200 microns with varying diameters, depending on application.

FIG. 3C is a view of an exemplary optical component of the present invention in the exemplary form of a disc that may be cut, shaped and polished into a lens in accordance with the present invention, which may comprise of composition and dopant amounts or concentrations detailed in Table III. For example, as detailed in Table III, for a lens, the optical component compositions may include Ba(PO₃)₂, 10 to 60 mol %; Al(PO₃)₃, 10 to 60 mol %; BaF₂+RFx, 20 to 90 mol %; with optimum Yb₂O₃ or YbF₃ dopant concentration is approximately 1-5 wt %. As detailed in Table III, RFx is one of MgF₂, CaF₂, BiF₃, YF₃, LaF3. Accordingly, the lens of the present invention with the mentioned composition concentrations detailed in Table III provides low dopant-concentration quenching, high optical transparency, and high radiation resistance.

The optical component of the present invention in the form of a lens has an Abba Number that is remarkably constant. That is, the change of linear refractive index in Ytterbium doped optical components of the present invention used as lens has been found to increase with increasing dopant concentration due to the dense packing of dopant materials into host materials, while the Abbe Number for the optical lens of the present invention is found to be remarkably constant, i.e., approximately 64-68 for a wide dopant concentration. On the other hand, the non-linear refractive index remained low at n₂=1.42×10⁻¹³ esu (electrostatic unit). The following table IV provides the optical characteristics of the lens of the present invention.

TABLE IV

| Yb₂O₃ | 0 wt % | 1 wt % | 2 wt % | 3 wt % | 4 wt % | 5 wt % |
|---|---|---|---|---|---|---|
| nF 486 nm | 1.5933 | 1.5940 | 1.5950 | 1.5965 | 1.5984 | 1.6003 |
| nD 589 nm | 1.5872 | 1.5878 | 1.5888 | 1.5898 | 1.5919 | 1.5940 |
| nC 656 nm | 1.5847 | 1.5850 | 1.5860 | 1.5873 | 1.5894 | 1.5915 |
| Abbe | 68.28 | 65.31 | 65.42 | 64.10 | 65.76 | 67.50 |
| Number | | | | | | |

The manufacturing process of the optical components of the present invention can be maximized by using the non-limiting, exemplary pot melt process, where materials are manufactured in an inert atmosphere created by Ar or other inert gases. The melting of the main batch (comprised of Al(PO₃)₃—Ba(PO₃)₂—BaF₂+RFx+dopant) is conducted in different types of crucibles, depending on the final optical component application and use. In general, the presence of Platinum (Pt) is considered to be a major contamination issue for processing of most optical components. The presence of Pt in optical components substantially lowers their radiation resistance levels. Accordingly, for high radiation energy applications the preferred, non-limiting example of a crucible used may include the use of vitreous carbon or graphite crucibles, rather than a Platinum based crucible. In general, the use of vitreous carbon or graphite crucibles control the overall allowable contamination of the main batch with respect to Pt, up to 500 ppb of Platinum (Pt). On the other hand, for application not requiring high energy levels of resistance 95% Pt and 5% Au non-stick crucible, or, alternatively, 100% Pt crucible may be used. In these applications, the Pt contamination was found to be 5000 ppb, which is acceptable for optical components, including for those with some levels of radiation resistance.

To continue with the pot melt process, the main batch is melted at approximately 1100° C. to 1280° C. (e.g., preferably, 1260° C.) for 4 to 6 hours or more until a homogeneous melt is achieved. The homogeneity of the melt is enhanced by mixing the melt. Next, the glass of the present invention is poured into a mold for cooling and annealing. The cutting, shaping, and polishing of the optical components is then produced from the main bulk for desired applications.

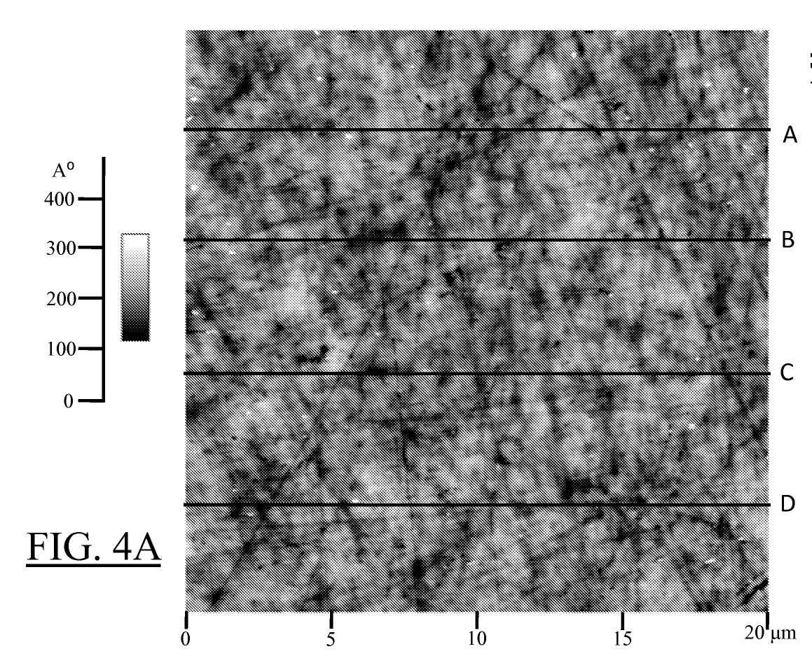

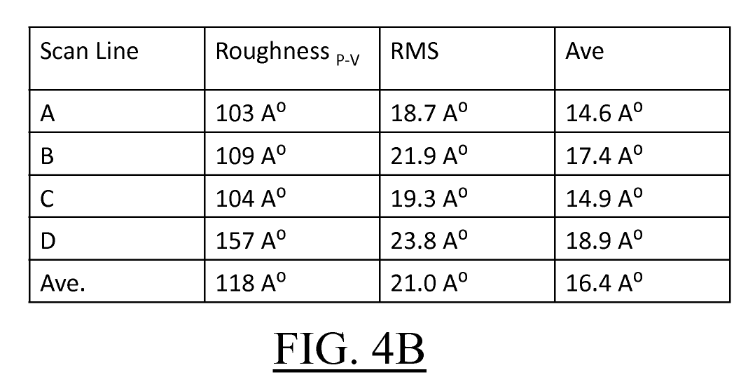

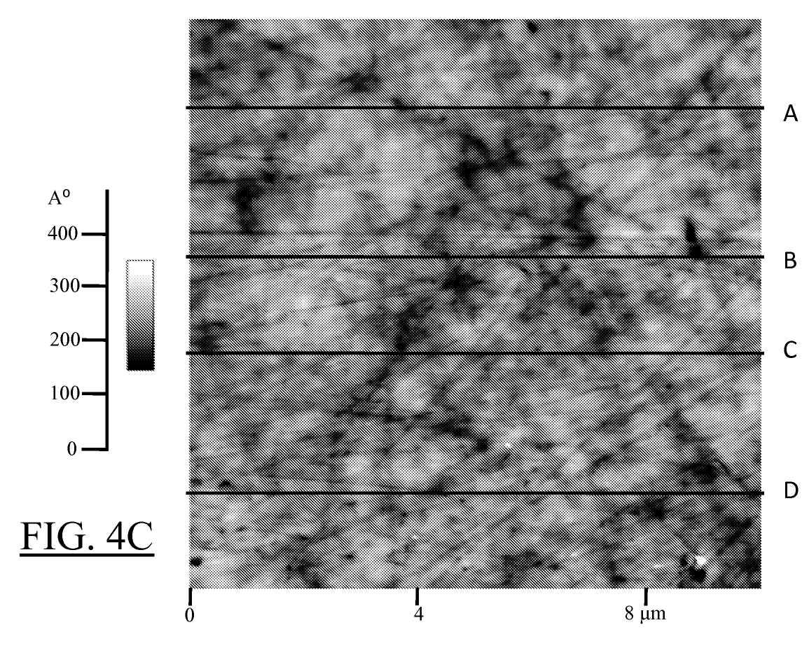

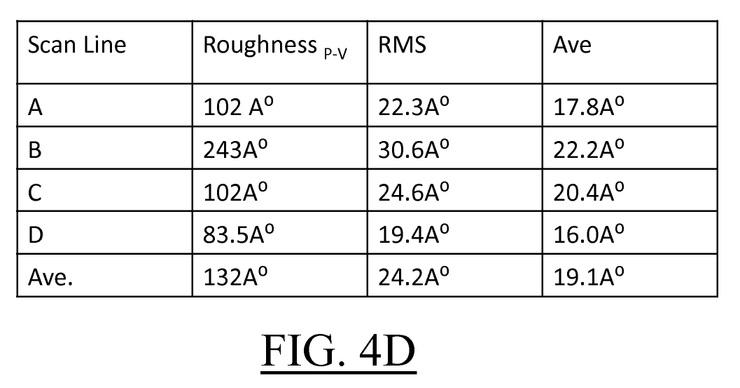

The next process is to cut the optical components into desired configurations for required applications, which would require the polishing of the cut surfaces of the optical components. The optical components of the present invention can be polished in accordance with industry requirements. However, it should be noted that most conventional fluorophosphate based glass systems cannot be polished to levels in accordance with the present invention (indicated in the tables of FIGS. 4B and 4D) because they have a very low chemical durability in that they dissolve in polishing substances, such as water during the polishing process.

FIG. 4A exemplarily shows one polished side of a cubed optical component of the present invention, and FIG. 4B is a table, which details the numerical data with respect to the surface quality in terms of polished optical component end product for the side shown in FIG. 4A. FIG. 4C exemplarily shows another polished side of the same cubed optical component of the present invention shown in FIG. 4A, and FIG. 4D is a table, which details the numerical data with respect to the surface quality in terms of polished optical component end product for the side shown in FIG. 4C. It should be noted that the physico-chemical and thermo-mechanical characteristics of the optical components of the present invention enable the polishing of the present invention optical components at levels indicated in the FIGS. 4B to 4D. The following table V is an exemplary, non-exhaustive, non-limiting listing of physico-chemical and thermo-mechanical characteristics of the optical components of the present invention:

TABLE V

| Present Invention Optical Components | Yb₂O₃ dopant |
|---|---|
| Thermo-mechanical | |
| Knoop Hardness (kgf/mm²) | 335.6 to 359.2 |
| Thermal Expansion (micrometer/° C.) | 0.02295 to 0.02309 |
| Physical | |
| Density (g/cc) | 4.248 to 4.574 |

It should be noted that the act of polishing of the optical components of the present invention to levels detailed in FIGS. 4A to 4D in accordance with the present invention is required and important for most optical applications, which is not possible with most conventional fluorophosphate glass systems. FIG. 4A is an actual microscopic photograph of a small section (about 20 micrometers) of a side of the polished surface of the sample optical component of the present invention. FIG. 4C is also an actual microscopic photograph of a small section (about 8 micrometers) of another side of the polished surface of the same sample optical component of the present invention shown in FIG. 4A. The indicated horizontal lines A, B, C, and D are horizontal scanning lines of the polished surface of the sampled optical component. The sampled optical component was scanned along the horizontal lines A, B, C, and D for measuring surface variations (e.g., depth) after sample was completely polished, with the resulting data illustrated in the corresponding respective tables of FIGS. 4B and 4D.

FIGS. 4B and 4D are tables that show extrapolated data from the measured scan lines A, B, C, and D of the respective FIGS. 4A and 4C. As illustrated in the tables of FIGS. 4B and 4D, each respective row of the table corresponds to respective scan lines A, B, C, and D in respective FIGS. 4A and 4C. As illustrated in table of FIG. 4B, the extrapolated data from the respective scan lines of FIG. 4A has an average Roughness Peak-to-Valley (Roughness_{P-V}) of about 118 A°, with an average Root-Mean-Square (RMS) of about 21.0 A°, and an average of about 16.4 A°. As illustrated in table of FIG. 4D, the extrapolated data from the respective scan lines of FIG. 4C has an average Roughness Peak-to-Valley (Roughness_{P-V}) of about 132 A°, with an average Root-Mean-Square (RMS) of about 24.2 A°, and an average of about 19.1 A°.

The results of (FIG. 4A and FIG. 4C) of the same optical component of the present invention clearly indicate that the surface of the polished sampled optical component of the present invention is near perfect. That is, the polished surface has minimal roughness. This negligible roughness meets and exceeds the polished surface requirements for most (if not all) optical applications. In addition, it should be noted that the minimal, negligible roughness level measurement of the polished surface of the sampled optical component enables the use of the optical components of the present invention in very high power lasers by improving their overall performance. That is, the reduced roughness substantially reduces surface losses due to laser light scattering, which are minimized as a result of polishing. In addition, such high levels of polishing enables the final product to be tested at various laser damage threshold levels (detailed above). As mentioned, most conventional optical components cannot be polished to levels in accordance with the present invention (indicated in the tables of FIGS. 4B and 4D) because they have a very low chemical durability in that they dissolve in polishing substances, such as water during the polishing process.

As stated above, the optical components of the present invention have applications in numerous fields that may be used in high energy environments that may also require high laser damage threshold, one non-limited example of which is an optical fiber (active or passive). Generally, the conventional fluorophosphate based glasses have a tendency to become crystallized during what is known as the fiber drawing process to produce optical fibers. Accordingly, conventional fluorophosphate based glasses are generally not used to produce optical fiber components. The drawback with most conventional fluorophosphate based glasses is that the rate of change of their viscosity in relation to variations in temperature is usually high, wherein crystallization takes place. That is, small increments in increases in temperature greatly reduces their viscosity, within which crystallization occurs, which prevents the use of most conventional fluorophosphate based glasses for making optical fiber products. In other words, with most conventional fluorophosphate based glasses, their drawing (or pulling temperature) T_{D} (when they become sufficiently viscous to be pulled into a fiber) is very close (i.e., similar) to their crystallization temperature T_{C}, so they crystallize. Other factors contributing to crystallization may include, for example, the use of alkali elements in the glass composition, which has the tendency to increase crystallization during the fiber draw process. However, the optical components of the present invention do not have alkali elements, and have pulling or drawing temperature T_{D} that is substantially different from their crystallization temperature T_{C}. Accordingly, the optical components of the present invention are easily modified to manufacture and produce optical fibers with high radiation resistance and high laser damage thresholds, and were successfully pulled to a transparent fiber (FIGS. 1A and 1B), using the following relatively low cost techniques.

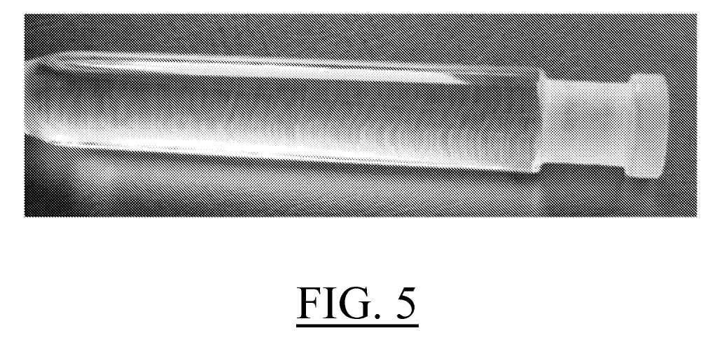

The manufacturing process for producing fiber (the “fiber draw”) (exemplarily shown in FIGS. 1A and 1B) from the optical components of the present invention (Al(PO3)3-Ba(PO3)2-BaF2+RFx+dopant) was generally done within an inert gas atmosphere, such as Ar gas. The fiber drawing (or the fiber production from the “rod” of glass system produced from the Melt Pot process above) is conducted in an inert gas (e.g., Ar) atmosphere by the application of heat as follows. An example of an optical component in the exemplary form of a glass-rod in accordance with the present invention is shown in FIG. 5.

The heat up schedule for the optical component of the present invention in the form of a rod shown in FIG. 5 was as follows:
3° C./minute up to just above the glass transition temperature (Tg) of 540° C., 5 minute hold there, then 5° C./min. to 620° C., the anticipated draw temperature.
10 minute hold at 620° C. When no drop obtained, increased to 630° C.
5 minute hold at 630° C. When no drop obtained, increased to 640° C.
5 minute hold at 640° C. When no drop obtained, increased to 650° C.
5 minute hold at 650° C. When no drop obtained, increased to 660° C.
5 minute hold at 660° C. When no drop obtained, increased to 670° C.
5 minute hold at 670° C. When no drop obtained, increased to 690° C.
5 minute hold at 690° C. When no drop obtained, increased to 710° C.
Obtained a drop at 710° C. Lower temperature to 690° C.

As noted above, the “rod” glass of the present invention (shown in FIG. 5) was heated at 3° C./minute up to just above the glass transition temperature (Tg) of 540° C. The glass transition temperature (Tg) is the threshold wherein the glass transitions from a solid state to a more malleable (e.g., soft) condition. The rod glass of the present invention was then held at 540° C. for about 5 minute, which created a uniform thermal condition for the whole rod. Thereafter, the “rod” glass was then exposed to a progressively increasing rate of temperature of about 5° C./min. up to 620° C., which is the anticipated draw temperature for the optical fiber component of the present invention.

As further noted above, the rod glass was held at 620° C. for about 10 minutes. However, no “drop” or “fall” in the rod glass was observed. That is, the rod glass did not become sufficiently malleable or soft where it could stretch and drop or fall onto a fiber draw reel (shown in FIG. 1A) for drawing or pulling the rod glass into strands of the optical fiber component of the present invention. Accordingly, the “rod” glass was then exposed to an increased temperature of 630° C., where the rod glass was held at 630° C. for about 5 minutes. However, no “drop” or “fall” in the rod glass was observed, and accordingly, the temperature was increased to about 640° C. The process continued on as noted above until a drop was obtained at 710° C., where the temperature was then lowered to 690° C.

The following are the draw observations from the above fiber draw method. The initial drop obtained at 710° C. showed that the draw tension was too low, accordingly, the temperature was lowered to 690° C. The fluorophosphate rod of the present invention appeared to draw well at this temperature, with some slight surface crystallization noted on the initial drop, but was clear up as the draw was established. Over 1,200 feet of the optical fiber component sample of the present invention was collected (drawn or pulled) during this experiment from the fluorophosphates glass system of the present invention in the form of an exemplary rod shown in FIG. 5 with dimensions of about 10 mm (diameter) and about 97.1 mm (length). After the draw, the fiber strength noted in tension appeared good for this type glass, and the rod was cooled down at 3° C./min. It should be noted that similar process may be used for producing the core and the cladding elements of the optical fiber component of the present invention.

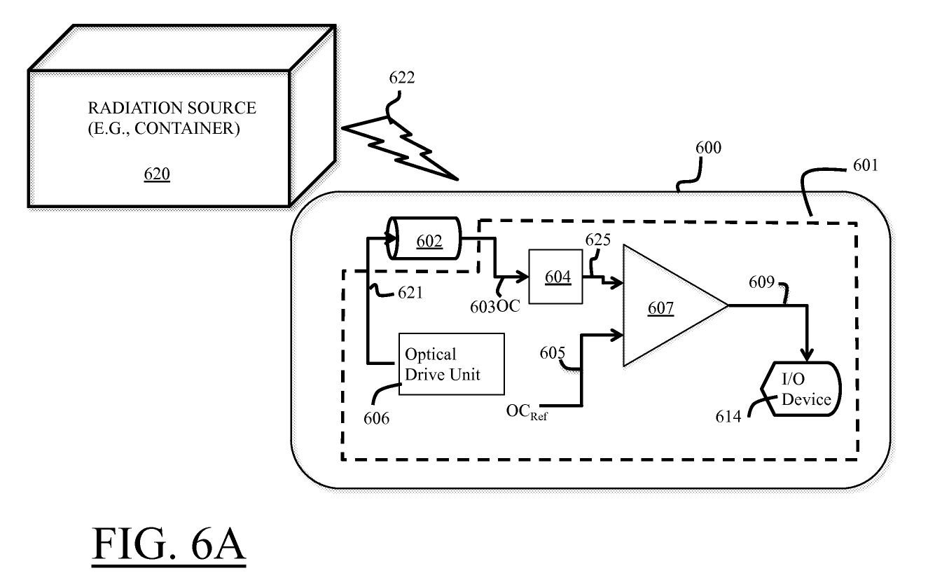

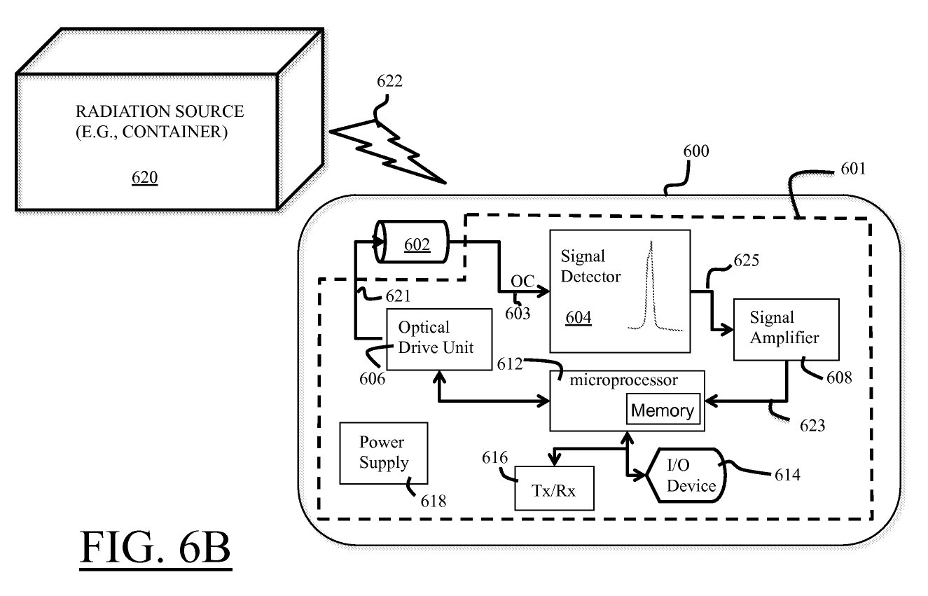

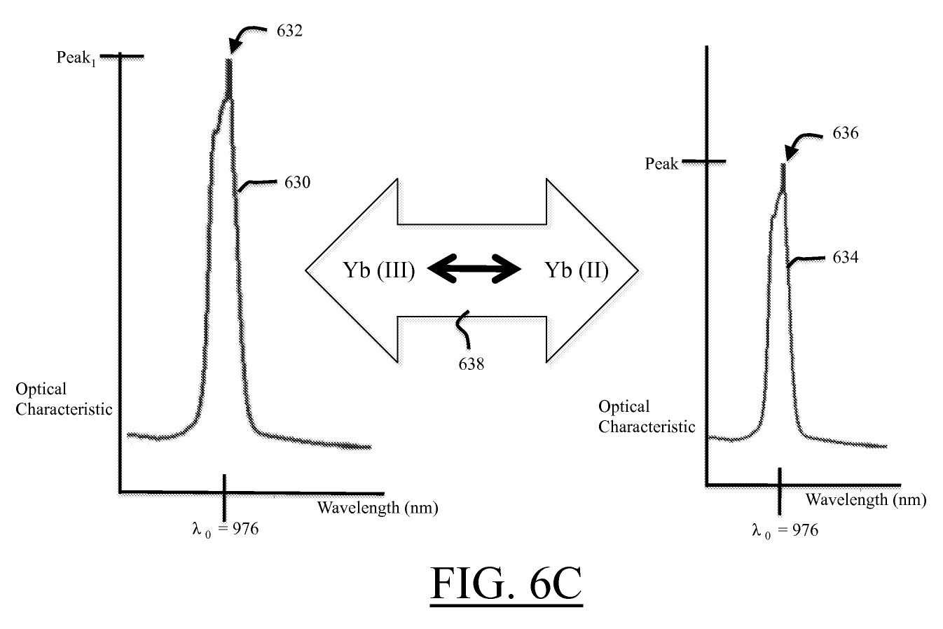

FIG. 6A is an exemplary, general schematic illustration of a radiation detection system in accordance with the present invention; FIG. 6B is an exemplary illustration of another a radiation detection system in accordance with the present invention; and FIG. 6C is an exemplary graphical illustration of one, non-limiting example of an optical characteristic of the optical component that is used in the radiation detection systems illustrated in FIGS. 6A and 6B in accordance with the present invention.

The present invention provides a radiation detection system 600 that includes an optical component 602 and a radiation detection mechanism 601 that may be used to detect various levels of radiation 622 from a radiation source 620, non-limiting example of which may include emissions of radiation 622 from a container 620 such as a shipping container. As illustrated in FIG. 6A, the radiation detection system 600 is comprised of an optical component 602 having various levels of temporary fluctuating optical characteristics (i.e., temporary, but continuous reciprocating transformations) associated with variations in different levels of environmental radiation 622 (of at least 6.4 eV of energy or higher). Also included is a radiation detection mechanism 601 that detects the various levels of temporary fluctuations in the optical characteristics of the optical component 602 as a result of the variations in levels of environmental radiation 622. In other words, the temporary, continuous reciprocating transformation of the optical characteristics of the optical component 602 results in corresponding temporary fluctuations thereof that is detected by the detection mechanism 601.

The detection mechanism 601 of the present invention monitors via a detector circuit 604 levels of variations in optical characteristics OC 603 of the optical component 602 and uses a comparator 607 to compare them with reference optical characteristics OC_{REF} 605, the differences of which (if any) result in an output comparator signal 609 that is indicative of existence of radiation 622 (or the lack thereof), which is displayed by an input-output (I/O) device 614. Non-limiting, non-exhaustive listings of examples of optical characteristics OC include at least one of optical density, optical absorption, optical transparency, and change in valence energy of the optical component 602. Therefore, the existence of environmental radiations 622 (with minimum of at least 6.4 eV energy or higher) are determined based on the differences between optical characteristics OC 603 of the optical component 602 and the known or predetermined optical characteristics reference OC_{REF} 605 (or deviations thereof) of the optical component 602 using the detector circuit 604 and comparator 607, the results of which is output as a comparator signal 609 to the I/O device 614.

As further illustrated in FIG. 6A, the detection mechanism 601 further includes an optical driver unit 606 that continuously drives the optical component 602 to produce the optical characteristic OC 603, which is detected by the detector circuit 604 for comparison with the reference optical characteristic OC_{REF} 605 by the comparator 607. The optical drive unit 606 constantly and continuously drives the optical component 602 for continuous generation of the optical characteristic signal OC 603 for monitoring various radiation levels (of at least 6.4 eV energy or higher). A non-limiting example of an optical drive unit 606 may include a signal generator that continuously generates drive signals 621 to drive the optical component 602. Non-limiting example of a drive signal 621 may include Infrared (IR) drive signal 621 having a non-limiting, exemplary wavelength ranging from about λₐ=970 nm to about λ_{b}=980 nm to drive the optical component 602. It should be noted that the drive signal characteristics (electromagnetic radiation level, wavelength, etc.) should be associated with the particular constitution of the optical component (e.g., the glass system, dopant, dopant concentration, etc.). In this exemplary instance using Yb as dopant for the optical component 602, it is preferable to use Infrared (IR) drive signal 621 having a non-limiting, exemplary wavelength ranging from about λₐ=970 nm to about λ_{b}=980 nm, and more particularly, IR drive signal 621 with wavelength λ₀=976 nm. The IR drive signal 621 with wavelength λ₀=976 nm generates one, single optical density (or absorption or transparency) peak for the Yb dopant in the optical component 602 of the present invention, with the levels of intensity or the value of the one, single optical density (or absorption or transparency) peak varying commensurate with the levels of radiation 622 (more detailed below).

As further illustrated in FIG. 6A, the drive signal 621 is directed at the optical component 602, the output of which produces the optical characteristic signal OC 603 (exemplarily illustrated as signal 630 in FIG. 6C) with a peak optical density (or absorption or transparency) 632. The detector circuit 604 then detects the generated signal OC 603 and outputs a detected signal 625 to the comparator 607. Accordingly, if no radiation 622 exists, then the optical characteristic signal OC 603 detected will be identical to its normal or known optical characteristic signal (e.g., the reference optical characteristic OC_{REF} 605) in response to the particular drive signal 621.

A non-limiting example of an optical characteristic of the optical component 602 used for determining detection of radiation may include the transparency of the optical component 602. Transparency may be defined by the amount of passage of electromagnetic radiation through the optical component 602. Accordingly, the amount by which the electromagnetic radiation (i.e., the IR drive signal 621 with wavelength λ₀=976 nm) is allowed passage through the optical component 602 may be detected and compared with the reference optical characteristic OC_{REF} 605. The resulting comparator output signal 609 is analyzed to determine the existence (if any) of radiation 622.

Upon application or sensing of radiation 622, the optical characteristics OC 603 of the optical component 602 (which is continuously output as a result of optical driver unit 606) temporarily and commensurately varies in relation to the level of radiation 622, resulting in commensurate rate of continuous reciprocating transformations 638 of the optical characteristics OC 603 exemplarily illustrated in FIG. 6C, back-and-forth between exemplary signals 630 and 634. That is, the optical characteristics OC 603 temporarily but continuously changes (with the rate of change commensurate with the levels of radiation) from the exemplary signal 630 to signal 634 and vice versa, with the peak optical density (or absorption or transparency) temporary but continuously also varying from peak at 632 to peak at 636 and vice versa. In other words, the higher the level of radiation 622 (of at least 6.4 eV or higher), the higher the rate of change (or frequency) of the transformation 638.

Using transparency as non-limiting example of an optical characteristic, when radiation 622 is applied, the amount by which electromagnetic radiation (i.e., the continuous application of the IR drive signal 621 with wavelength λ₀=976 nm) that passes through the optical component 602 will temporarily fluctuate commensurate with the level of radiation 622, and be output as the optical characteristic signal OC 603. In other words, the temporary, commensurate fluctuation of transparency of the optical component 602 due to corresponding levels of application of radiation 622 correspondingly, temporarily affects the amount of passage of electromagnetic radiation (within the Infrared wavelength, λ=976 nm), which may be detected by the detecting circuit 604. The detected temporary fluctuation level of signal OC 603 (and or deviations from the norm for the optical component 602) is then output as detected signal 625 and compared with the reference (or normal) optical characteristic OC_{REF} 605 of the optical component 602 to determine the detected radiation levels. As further illustrated in FIG. 6A, the comparator circuit 607 compares the changes in the optical characteristic signal OC 603 (e.g., the variations in the signal peaks 632 and 636 of the IR drive signal 621 at wavelength λ₀=976 nm) with the reference optical characteristic OC_{REF} 605 (e.g., peak 632 may be used as the reference) for determining commensurate or corresponding environmental radiation levels, the results of which is output as comparator output signal 609 to the I/O device 614 for further analysis.

More specifically, the optical component 602 of the present invention is comprised of the dopant selected from one of Yb₂O₃ and YbF₃ over 100 percent (wt %) of the composition above Yb, which can generate a single peak optical density (or absorption or transparency) level 632 at Peak₁ (FIG. 6C) when driven by the optical drive unit 606 at IR frequency signal within wavelengths ranging from about λₐ=970 nm to about λ_{b}=980 nm, more preferably, at wavelength λₒ=976 nm. The value of the single peak of the optical density (or absorption or transparency) level Peak₁ 632 of the Yb dopant within the optical component 602 temporarily continues to vary substantially proportional to the sensed levels of radiation 622. As has been described, the added energy (e.g., 6.4 eV or higher) sets into motion the continuing, temporary, reciprocating transformation 638 of the valency of Yb of the optical component 602 from Yb(III) to Yb(II), and Yb(II) to Yb(III) as follows (with the rate or frequency of transformation 638 substantially commensurate with the level of applied radiation 622):

Yb(III)+hν+e<->Yb(II)-hν-e

Yb(III)+e<->Yb(II)-e

Yb(III)<->Yb(II)

where Yb(III) is Yb that is combined with Oxygen or Fluoride in the form of Yb₂O₃ or YbF₃ in its normal state, and Yb(II) is the result of Yb(III) gaining an electron as a result of excitation of the dopant due to application of radiation; hν is environmental energy (such as the radiation 622), with h as a Planck Constant and ν as a frequency, and e as an electron. As has been described above, this continuous reciprocating (or back and forth) transformation process 638 of Yb as a result of application of energy (e.g., radiation 622) enables the optical component 602 to maintain its overall optical characteristics, but also exhibits commensurately measurable (temporarily, continuous reciprocating rate of transformation) varying optical characteristics (e.g., temporary changes in peak optical density (or absorption or transparency) level), which is detected by the detection mechanism 601 of the present invention. The measurable temporary fluctuation levels in the optical characteristics are used to determine corresponding radiation levels 622 when compared with the optical characteristics of the optical component 602 under no radiation (e.g., optical signal 630 of Yb (III)). Maintaining the overall optical characteristics (e.g., transparency) of the optical component 602 while measuring environmental radiation levels is important in that the optical component 602 need not be replaced as a result of exposure to radiation, thereby substantially reducing the overall maintenance and replacement costs, with no downtime for detection of containers or other environmental radiation sources. Further, the present invention has a small form-factor, enabling the entire radiation detection system 600 to be mobile and portable, readily moved proximal any radiation source for detections of radiation. Additionally, upon removal of radiation 622, the temporary, continuous reciprocating rate of corresponding transformation of the optical characteristics that result in temporary fluctuation levels thereof cease, and the optical characteristic of the optical component 602 revert back to their normal, stable state. This enables reuse of the optical component 602.

As has been stated above, the optical component 602 may comprise of a metaphosphate Ba(PO₃)₂ in mol %, a metaphosphate Al(PO₃)₃ in mol %, fluorides BaF₂+RFx in mol %, with dopant selected from one of Yb₂O₃ and YbF₃ over 100 percent (wt %) of the composition above Yb. The R is selected from the group consisting of Mg, Ca, Bi, Y, La, and the x is an index representing an amount of fluorine (F) in the compound RFx;

An optical characteristic such as the optical density (or absorption or transparency) may be determined by the following:

$${D}_{1} = \frac{1}{{T}_{0}} {e}^{α cd}$$

where D₁ is the optical density, T₀ is the normal or constant optical transparency, α is the type of dopant used in the optical component 602 (e.g., Yb), c is the dopant concentration level (e.g., over 100 percent (wt %) of the composition above Yb), and d is the length of travel of the generated Infrared (IR) drive signal passing through the optical component 602 at the particular wavelength (e.g., IR drive signal with λ₀=976 nm) passing through the length d of the optical component 602. Accordingly, the value of the reference optical characteristics OC_{REF} 605 and the optical characteristic OC 603 as a result of the drive of the optical component 602 by the optical driver unit 606 can easily be calculated. Thereafter, upon application of added or external energy (e.g., 6.4 eV or higher), the temporary, continuous reciprocating transformation of the optical characteristics of the optical component 602 that result in temporary fluctuations levels of the optical characteristic OC 603 commensurate with the added energy (radiation 622) can be detected by the detector circuit 604 and compared by the comparator 607 with reference OC_{REF} 605 to determine radiation levels 622. Hence, initially, when no radiation 622 exists, the values of optical characteristics OC_{REF} 605 and the optical characteristic OC 603 will be equal (which is the optical characteristic signal 630 for Yb(III)). However, the optical characteristic OC 603 will temporarily, and continuously fluctuate (i.e., the temporary, continuous reciprocating transformation of the optical characteristics result in temporary fluctuations levels thereof) upon continuous application of radiation 622 (e.g., OC 603 will exhibit continuous back-and-forth reciprocating transformations 638 between the optical characteristic signal 630 of Yb(III) and optical characteristic signal 634 of Yb(II)).

FIG. 6B is exemplary illustrations of a radiation detection system with further details in terms in accordance with the present invention. The radiation detection system of FIG. 6B includes similar corresponding or equivalent components, interconnections, and or cooperative relationships as the radiation detection system that is shown in FIGS. 6A, and described above. Therefore, for the sake of brevity, clarity, convenience, and to avoid duplication, the general description of FIG. 6B will not repeat every corresponding or equivalent component and or interconnections that has already been described above in relation to the radiation detection system that is shown in FIG. 6A.

As illustrated in FIG. 6B, the radiation detection mechanism 601 includes a power source 618 that powers the various electronic components of the detection mechanism 601. Further included is the signal detector 604 that detects optical characteristic signals OC 603 (e.g., 630 and 634 of FIG. 6C), which are amplified by well-known signal amplifier 608 and input to a microprocessor 612 for analysis. Non-limiting example of a signal detector 604 may exemplarily include electromagnetic radiation detector for detection of the amount of the drive signal 621 that passes through the optical component 602.

The signal amplifier 608 increases the signal strength of the detected signal 625 that is output from the signal detector 604 sufficiently for further processing by the microprocessor 612. The signal amplifier 608 may comprise of a transistor functioning to amplify the exemplary signals 630 and 634 that are output from signal detector 604. It should be noted that the present invention should not be limited to a single signal amplifier 608 illustrated and further, the amplification need not be performed by a transistor, but can be done by other passive or active devices, or any combinations thereof. As further illustrated, the amplified signal 623 is input to the microprocessor 612, where the microprocessor 612 converts the analog amplified signal 623 into digital signals for processing. These digitized signals are translated by the instructions (algorithm) within a memory of the microprocessor 612 to determine the existence of radiation 622, and if so, the microprocessor 612 would output such information via the transceiver 616 and or the I/O device 614.

One non-limiting example of the microprocessor 612 may be a general-purpose microprocessor mounted onto a Printed Circuit Board (not shown) with memory (e.g., an EEPROM, RAM, ROM, etc.) that includes a set of instructions for executing various functions. The memory retains the detected signals 623 information, and includes comparator functionality instructions (or algorithms) for determining variations in detected signals 623, which are reflective of temporary continuous reciprocating transformation or variations in optical characteristics (e.g., optical density (or absorption or transparency) levels) of the optical component 602 under radiation.

In general, the microprocessor 612 receives one or more input signals from one or more input periphery devices and generates one or more processed output signals for actuation of one or more periphery output devices. The processing of data may include Analog to Digital (A/D) or D/A conversion of signals, and further, each input or pin of the microprocessor 612 may be coupled with various multiplexers to enable processing of several multiple input signals from different input periphery devices with similar processing requirements. Non-limiting examples of one or more input periphery devices may exemplarily include the amplified signals from the signal amplifier 608 and or transmitted control signals from a transceiver unit 616, and the non-limiting examples of one or more output periphery devices may exemplarily include the Input/Output device 614 to indicate the existence of radiation 622 and the transceiver 616 for wirelessly transmitting the results of the detected radiation 622 to some central station (if need be). Non-limiting examples of an I/O device 614 may include the use of a computer display screen, vibration mechanisms, audio, visual or any other indicators to alarm and or notify a user regarding radiation 622.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, a multiplicity of optical components 602 may be used, the output signals of which may be input to one or more detection mechanisms 601. The various components that constitute the detection mechanism 601 may be implemented in hardware, software, or combinations thereof. In addition, it should be noted that none of the FIGS are to scale. The radiation detection system may be implemented in hardware, software, or combinations thereof. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A radiation detection system, comprising:
an optical component having fluctuating optical characteristics associated with variations in environmental energy levels; and
a detection mechanism that detects fluctuations in optical characteristics of the optical component, thereby enabling determination of environmental radiation levels.

2. The radiation detection system as set forth in claim 1, wherein:
the detection mechanism monitors variations in optical characteristics of the optical component, with the optical characteristics including at least one of optical density, optical absorption, optical transparency, and change in valence energy of the optical component.

3. The radiation detection system as set forth in claim 2, wherein:
environmental radiation levels are determined based on the variations of the optical characteristics of the optical components from known optical characteristics.

4. The radiation detection system as set forth in claim 2, wherein:
environmental radiation levels are determined based on deviations of the variations of the optical characteristics of the optical components from known optical characteristics.

5. The radiation detection system as set forth in claim 3, wherein:
the optical component is comprised of a dopant selected from one of Yb₂O₃ and YbF₃ over 100 percent (wt %) of the composition above Yb, with single optical density peak within wavelengths ranging from about 970 nm to about 980 nm.

6. The radiation detection system as set forth in claim 3, wherein:
the optical component is comprised of:
a metaphosphate Ba(PO₃)₂ in mol %,
a metaphosphate Al(PO₃)₃ in mol %,
fluorides BaF₂+RFx in mol %,
with dopant selected from one of Yb₂O₃ and YbF₃ over 100 percent (wt %) of the composition above Yb;
where:
R is selected from the group consisting of Mg, Ca, Bi, Y, La;
x is an index representing an amount of fluorine (F) in the compound RFx;
with the optical components maintaining transparency in high energy environments.

7. The radiation detection system as set forth in claim 4, wherein:
the optical density peak of the Yb dopant within the optical component varies as a result of continuing transformation of a valency of Yb from Yb(III) to Yb(II), and Yb(II) to Yb(III) as follows:
Yb(III)+hν+e<->Yb(II)-hν-e
Yb(III)+e<->Yb(II)-e
Yb(III)<->Yb(II)
where hν is environmental energy, with h as a Planck Constant and ν as a frequency, and e is an electron.

8. A radiation detection system, comprising:
an optical component having fluctuating optical absorption level associated with variations in environmental energy levels; and
a detection mechanism that detects fluctuations in optical absorption level of the optical component;
the detection mechanism includes:
a signal detector that detects signals associated with the optical absorption levels of the optical component;
a signal amplifier for amplification of the detected signals;
a microprocessor for determining variations in the detected signals to thereby determine variations in environmental energy levels.

9. The radiation detection system as set forth in claim 8, wherein:
a microprocessor is associated with a memory that retains detected signals information, and includes a comparator for determining variations in detected signals, which are reflective of variations in optical absorption levels of the optical component.

10. The radiation detection system as set forth in claim 9, wherein:
the detection mechanism further includes:
an optical driver unit for generating Infrared (IR) signal having a wavelength ranging from νₐ=970 nm to λ_{b}=980 nm that is passed through the optical component for generating a substantially constant absorption signal with a first peak optical absorption level P₀;
the optical component generating a second absorption signal within the wavelength range λₐ=970 nm to λ_{b}=980 nm with a second peak optical absorption level associated with externally applied environmental radiation;
a comparator for determining differences between the second peak optical absorption level and the first peak optical absorption level for determining environmental radiation levels.

11. The radiation detection system as set forth in claim 10, wherein:
the Infrared (IR) signal has a wavelength λ₀=976 nm.

12. The radiation detection system as set forth in claim 9, wherein:
the optical component is comprised of a dopant selected from one of Yb₂O₃ and YbF₃ over 100 percent (wt %) of the composition above Yb, with single peak optical absorption level within wavelengths ranging from about 970 nm to about 980 nm.

13. The radiation detection system as set forth in claim 9, wherein:
the optical component is comprised of:
a metaphosphate Ba(PO₃)₂ in mol %,
a metaphosphate Al(PO₃)₃ in mol %,
fluorides BaF₂+RFx in mol %,
with dopant selected from one of Yb₂O₃ and YbF₃ over 100 percent (wt %) of the composition above Yb;
where:
R is selected from the group consisting of Mg, Ca, Bi, Y, La;
x is an index representing an amount of fluorine (F) in the compound RFx;
with the optical components maintaining transparency in high energy environments.

14. The radiation detection system as set forth in claim 10, wherein:
the peak optical absorption level of the Yb dopant within the optical component varies as a result of continuing transformation of a valency of Yb from Yb(III) to Yb(II), and Yb(II) to Yb(III) as follows:
Yb(III)+hν+e<->Yb(II)-hν-e
Yb(III)+e<->Yb(II)-e
Yb(III)<->Yb(II)
where hν is environmental energy, with h as a Planck Constant and ν as a frequency, and e is an electron.
